(19) United States
(12) Patent Application Publication
(10) Pub. No.: US 2015/0326921 A1
(43) Pub. Date: Nov. 12, 2015

(54) SYSTEM AND METHOD FOR PROVIDING AN EVENT-DRIVEN VIDEO/AUDIO CONTENT PLATFORM

(71) Applicant: Comigo Ltd., Yarkona (IL)

(72) Inventors: Avraham Makovetsky, Bnei Brak (IL); Ronen Segal, Herzliya (IL)

(21) Appl. No.: 14/588,445

(22) Filed: Jan. 1, 2015

Related U.S. Application Data
(60) Provisional application No. 61/990,128, filed on May 8, 2014.

(51) Int. Cl. H04N 21/443; H04N 21/442; H04N 5/445; H04N 21/81; H04N 21/845; H04N 21/431; H04N 21/475

(52) U.S. Cl. CPC H04N 21/4438; H04N 21/4316; H04N 21/442; H04N 21/4755; H04N 21/812; H04N 21/8456; H04N 5/44591

(57) ABSTRACT

The disclosure herein relates to providing a video/audio event-driven platform in digital environments. Particularly, the disclosure relates to systems and methods for controlling the video/audio content stream within a video playing session, automatically responding to events allowing the user to continue in a preferred engagement. The methods support operating a media terminal to present a first segment of video content in a first presentation mode, while a second presentation mode, associated with detectable video content events, may be used for a second segment.

### CROSS-REFERENCE TO RELATED APPLICATIONS

This application claims the benefit of U.S. Provisional Patent Application 61/990,128, filed May 8, 2014, the disclosure of which is hereby incorporated in its entirety by reference herein.

### FIELD OF THE DISCLOSURE

The disclosure herein relates to providing a video and audio event-driven platform for digital environments. In particular, the disclosure relates to controlling video and audio content streams automatically during a video playing session in response to events.

### BACKGROUND OF THE DISCLOSURE

Consumption of streaming media has increased significantly over recent years, with online viewers using various digital platforms, such as TVs, computers, laptops, tablets, smartphones, handheld devices and the like.

Commonly, consuming video/audio content in a broadcasting session may involve a wide range of dynamic events, partially related to the session itself like streaming of advertising messages, for example, or content-specific events, such as appearances of a specific actor, timeout periods in sports events, scoring of a goal, penalty kick in a sporting event, etc. Such events may be ignored by a consumer of video/audio content, and/or may trigger the consumer to switch to a different engagement with the content.

Providing video advertising content on mobile devices may blend two common approaches. The first comprises pre-stitching adverts into the content. The second is based on dynamic advertisement insertion, wherein advertisements are inserted at run-time while the media is being streamed. Dynamic advertisement insertion gives operators the flexibility to insert context-based advertisements, for example depending on the user's geographic location, the program content, the user's preferences, and/or any other suitable criteria.

Irrespective of the method of providing advertising, any advertising content may be considered by the viewer to be an intrusion. A viewer may switch to another program during an advertisement, move away from the active video screen, or close the video session altogether.

Thus, a need exists for a method to balance the user's needs with those of video content providers and digital marketers.

### SUMMARY OF SELECTED EMBODIMENTS

Embodiments described herein relate to a providing a video and audio event-driven platform for digital environments. In particular, the disclosure relates to controlling the video and audio content streams within a video playing session automatically, in response to events.

According to one aspect of the presently disclosed subject matter, a method is provided for operating a media terminal in an improved manner, the method comprising the steps of:
presenting a first segment of media content in a first presentation mode;
detecting, by the media terminal, an event in the media content;
upon detecting the event selecting, by the media terminal, a second presentation mode; and
presenting a second segment of media content in the second presentation mode.

The media content accessed by the media terminal may include, inter alia, video content, audio content, mixed video/audio media content, multimedia content, text-based content, or other suitable media content.

The step of detecting an event of the method may comprise the media terminal monitoring the media content.

Optionally, the step of detecting an event in the media content comprises the media terminal identifying an advertisement or a portion thereof, for example the beginning of an advertisement or the end of an advertisement.

Optionally, the step of detecting an event comprises the media terminal identifying a repeated section of the media content or a portion thereof, for example the beginning or end of a repeated section of the media content.

Optionally, the step of detecting an event comprises measuring time elapsed since a previous event and determining if the elapsed time has exceeded a threshold value.

The media content may be provided by a content provider, wherein the step of detecting an event may comprise the media terminal receiving a signal from the content provider.

Either of the steps of presenting a first segment of media content and presenting a second segment of media content may comprise displaying the media content in a full-screen display mode. The other of the steps may comprise displaying the media content in a partial screen display mode. When in partial screen display mode, the visual content may be displayed in a window, a floating window or in a banner.

The step of presenting a first segment of media content in a first presentation mode may comprise displaying the first segment of media content on a first display, with the step of presenting a second segment of media content in a second presentation mode comprising displaying the media content on a second display.

When the media content comprises an audio track and a video track, one of the steps of presenting a first segment of media content and presenting a second segment of media content may comprise playing only the audio track.

The step of presenting a first segment of media content in a first presentation mode may comprise displaying the first segment of media content at a first transparency level, with the step of presenting a second segment of media content in a second presentation mode comprising displaying the second segment of media content at a second transparency level.

Optionally, one of the first transparency level and the second transparency level is a zero transparency level corresponding to an opaque mode.

The step of presenting a first segment of media content in a first presentation mode may comprise displaying the first segment of media content with a first transparency pattern, with the step of presenting a second segment of media content in a second presentation mode comprising displaying the second segment of media content with a second transparency pattern. A transparency pattern is a mapping from pixel locations to transparency levels that defines what is the transparency level to apply to a given pixel. Using a transparency pattern that is not a constant mapping to a fixed transparency level allows the displaying of content with different transparency levels at different screen locations of the displayed content. For example, the first segment of media content may be displayed with a transparency pattern that is more transparent in the center than in the periphery of the screen, and the second segment of media content may be displayed with a transparency pattern that is more transparent in the periphery than in the center of the screen. Optionally, one or both of the first transparency pattern and the second transparency pattern is a constant transparency pattern causing all parts of the media content to be displayed at the same transparency level.

Either of the steps of presenting a first segment of media content and presenting a second segment of media content may comprise displaying the media content on a foreground display layer, with the other of the steps comprising displaying another display layer, which may be partially transparent, in front of the media content.

Either of the steps of presenting a first segment of media content and presenting a second segment of media content may comprise displaying another display layer in front of the media content using a first transparency level, with the other of the steps comprising displaying the another display layer in front of the media content using a second transparency level.

Optionally, one of the first transparency level and the second transparency level is a zero transparency level corresponding to an opaque mode.

Either of the steps of presenting a first segment of media content and presenting a second segment of media content may comprise displaying another display layer in front of the media content with a first transparency pattern, with the other of the steps comprising displaying the another display layer in front of the media content with a second transparency pattern. Optionally, one or both of the first transparency pattern and the second transparency pattern is a constant transparency pattern causing all parts of the media content to be displayed at the same transparency level.

The media terminal may comprise a display having a stack of ordered layers, wherein the step of presenting a first segment of media content in a first presentation mode comprises displaying the first segment of media content on a first display layer at a first position in the stack, and the step of presenting a second segment of media content in a second presentation mode comprising displaying the second segment of media content on a second display layer at a second position in the stack.

Optionally, the first display layer is behind the second display layer.

Optionally, at least one of the first display layer and the second display layer is partially transparent.

The media terminal may comprise a display having a stack of ordered layers, wherein the step of presenting a first segment of media content in a first presentation mode comprises displaying the first segment of media content on a first display layer at a first position in the stack and at a first transparency level, and the step of presenting a second segment of media content in a second presentation mode comprises displaying the second segment of media content on a second display layer at a second position in the stack and at a second transparency level. Optionally, one of the first transparency level and the second transparency level is a zero transparency level corresponding to an opaque mode.

Optionally, the step of presenting the second segment of media content comprises:
presenting a confirmation request to a user upon detecting the event;
receiving a confirmation from the user; and
presenting the second segment of media content in the second presentation mode.
   Additionally, the method may further comprise:
subsequent to the presenting of the second segment of media content, detecting, by the media terminal, a second event; and
upon detecting the second event, the media terminal presenting a third segment of media content in the first presentation mode.
   The step of presenting a third segment of media content may comprise:
upon detecting the second event, presenting a confirmation request to a user;
receiving a confirmation from the user; and
presenting the third segment of media content in the first presentation mode.

Optionally, the second event is selected from a group consisting of: a beginning of an advertisement, an ending of an advertisement, a beginning of a repeated section of the media content, an ending of a repeated section of the media content, an ending of a time interval since a previous event, and an instruction from a user.

Optionally, the media terminal comprises at least one of: a television, a computer, a laptop, a tablet, a smartphone, and a mobile communication device.

It is according to another aspect of the current disclosure to present a media terminal operable to present media content in a plurality of presentation modes, the media terminal comprising:
at least one video display operable to present the video content, and
a mode controller operable to detect an event in the video content, and to switch from a first presentation mode to a second presentation mode according to the event, the second presentation mode being selected by the media terminal.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1A is a schematic illustration of an example of a configuration of selected components of a centrally managed event-driven system for controlling a video content stream;

FIG. 1B is a schematic illustration of an example of a configuration for a network-based event-driven system for controlling a video content stream on various consumer devices;

FIGS. 2A-D illustrate examples of screen shots of a video event-driven platform according to an advertising control example, using minimization of a floating window;

FIG. 3 is a flowchart representing a method for operating a media terminal in a digital environment in an improved manner;

FIG. 4A is an illustration representing monitoring options for detecting an event in the video content displayed on a media terminal in digital environments;

FIG. 4B is a block diagram representing examples of display modes of the media terminal display system in a video monitoring system; and

FIG. 4C is a block diagram representing examples of presentation displays of the media terminal display system.

### DETAILED DESCRIPTION

Aspects of the present disclosure relate to systems and methods of providing an event-driven video/audio platform for controlling sessions according to content events on digital media devices such as television, smartphones, mobile communication devices, computers, laptops, tablets, or other suitable devices, enabling the user to continue in a different engagement.

As used herein, the term “event” refers to any automatically detectable occurrence related to media content. According to various embodiments, an event may be content related, for example the scoring of a goal in a soccer game, a scene change, the appearance of an actor or the like. Additionally or alternatively, an event may be system related, for example the receiving of a signal from a content provider providing streamed media content indicating the starting of a commercial, the end of a comercial or the like. Again additionally or alternatively, an event may be context related, for example the ending of a time interval elapsed since the occurrence of a previous event. Furthermore, an event may be synchronized or asynchronized to the media content. Where appropriate, an event may be detected by processing of the media content at the media terminal, or it may be signalled to the media terminal from outside. Additional examples of events are provided in the text below in a non limiting manner. Other examples will occur to those skilled in the art.

It is emphasized that an event is automatically detectable only if it does not involve human intervention in its detection. An event may be either automatically detected by the digital media device or be automatically detected by a content provider and signaled by it to the digital media device. Consequently, the pressing of a button or the input of a command in any other way, including by using a remote control, by a user of the digital media device is not considered to be an event for the purpose of this application.

It is further noted that as used herein, the term ‘event-driven’ refers to a platform that is designed to respond to events.

As used herein, the term “signal” refers to a sign used to convey information, an indication or an instruction, and which serves as means of communication for the management of a media content platform. A signal may be analog or digital. A signal may use a single line or multiple lines. A signal may use dedicated line(s) or be multiplexed on common line(s) with other signals.

As used herein, the term “floating window” refers to a display view that may be used to display arbitrary information that appears on top of all other windows in a computerized system, as if it is floating on top of them.

As used herein, the term “banner” refers to a message or a heading appearing on top of a window or a screen in the form of a bar, a column or a box.

In one embodiment of the current disclosure, for example, responding to an advertising message event may change the presentation mode of the video stream. Optionally, the mode change may automatically be determined using an advertising detection mechanism, for example using any suitable technology, including, but not limited to, automatic video content recognition using digital video/audio fingerprinting technology and content push mechanisms. Optionally, an event handler (e.g., event-driven) mechanism implemented for processing and responding to the various dynamic events may be used.

It is noted that the event-driven video content platform may be configured to respond to video/audio content events. For example, in one embodiment, the media stream containing the advertising message may be played within a floating window generated on a smartphone in response to an advertising-start event. Optionally, the media stream containing the advertising message may be displayed in a banner (static or dynamic). Alternatively, the media stream containing the advertising message may be directed to a secondary screen, a separate window, a secondary layer, a separate window pane or the like. Where appropriate, further control of separating the audio from the video stream of the advertising message, may be applicable.

It is further noted that the various options may be configurable via a user preference profile.

In various embodiments of the disclosure, one or more tasks as described herein may be performed by a data processor, such as a computing platform or distributed computing system, for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

The platform, methods, systems and architecture described hereinafter, are made purely by way of example to better illustrate various aspects of the current disclosure. It is noted that references made to events associated with advertising message stream, in various embodiments, are purely illustrated by way of example. It should be appreciated that various other video content events, occurring within a video session may be configured and monitored.

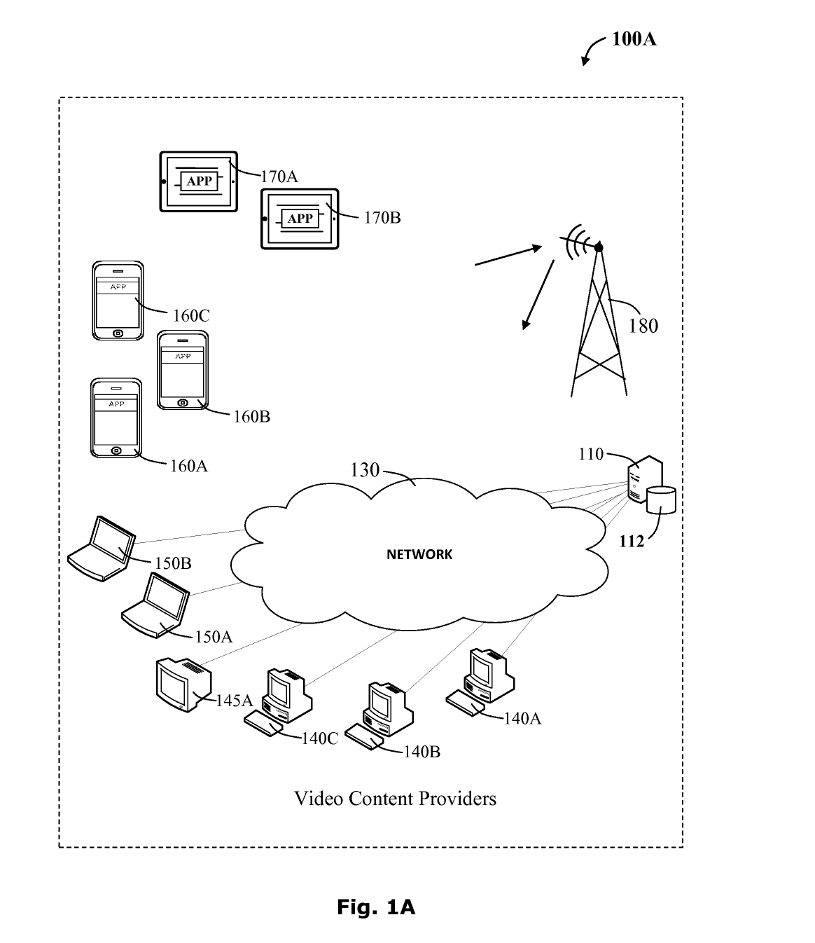

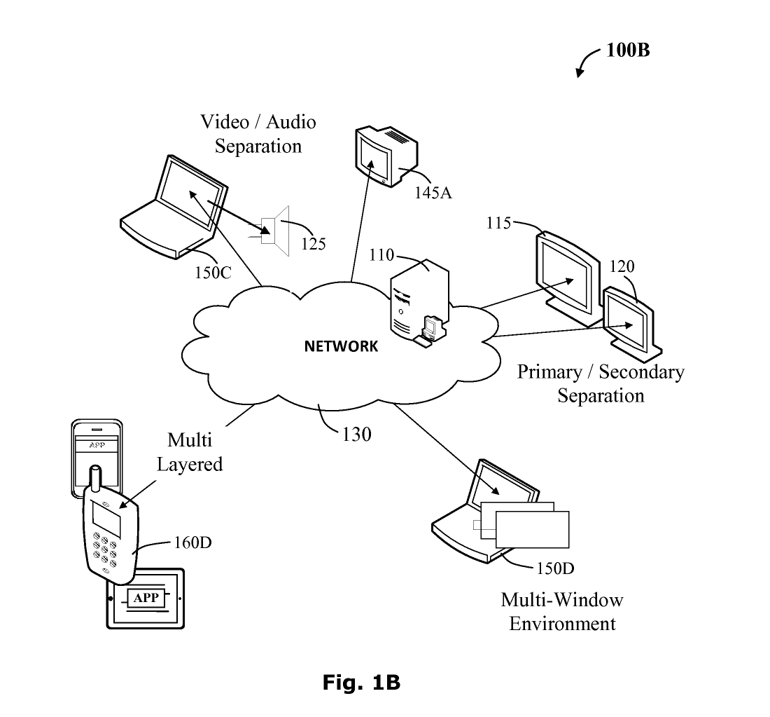

FIG. 1A describes a centrally managed architecture representing one embodiment of a configuration for a video/audio event-driven control platform, and FIG. 1B describes a network-based distributed architecture representing another embodiment of a configuration for a video/audio event-driven control platform.

### Centrally Managed System:

Reference is now made to FIG. 1A, showing a block diagram representing one embodiment of a configuration of selected elements of a system 100A for a video/audio event-driven platform, controlling various video content associated events, such as advertising messages, video/audio content specific events (time-out or penalty kick in a sporting event, for example) and the like, on various digital devices. The system 100A includes a centrally managed server 110, a central database 112 for storing video content, and various media terminals, such as video content providers 140A-C, users using various media terminals such as a television 145A, laptops 150A-B, smartphones 160A-C and tablets 170A-B. The media terminals (content provider, users) and the server may be in communication via a network 130, a mobile network 180 or any other means of wired or wireless communication.

When required, the centrally managed server 110 may be operable to send event-related signals to various media terminals, such as client terminals of media content providers' 140A-C, laptops 150A-B or smartphones 160A-C, consuming video content from the centrally managed server 110, where video content is stored in the central database 112. Additionally or alternatively, the various media consumers may consume video content from the centrally managed server, while the associated video events may be detected locally, using an algorithm executed by a local application.

It is noted that the management server may serve various control functionalities, while the main interactions with the users may be generated by software packages installed on the media terminals.

It is further noted that various media terminals may be used in the context of this invention, such as televisions, various types of personal computers, various types of portable computers, laptops, tablets, smartphones and mobile communication devices, handheld devices, gaming consoles, whiteboards, smartboards, dashboard screens, video screens and the like. Where appropriate, the media terminal may be connected via a set-top-box (STB) by one or more connectors such as a High-Definition Multimedia Interface (HDMI) connector, a Digital Visual Interface (DVI) connector, a Video Graphics Array (VGA) connector, a Universal Serial Bus (USB) connector, a Digital Interface for Video and Audio (DIVA) connector and the like, as commonly used in media communication.

### Network-Based Distributed System:

Reference is now made to the block diagram of FIG. 1B, representing another embodiment of a network-based distributed system configuration 100B for a video/audio event-driven content control.

The network-based distributed system 100B includes a centrally managed server 110 and various media terminals, for example having a multi-window or multi-layered display systems, and optionally having a primary screen 115 and a secondary screen 120, a television 145A, a laptop or PC 150D operable to run a Windows OS or a Mac OS as an example, various mobile devices 160D such as smartphones and tablets, and a system 150C configurable to allow an audio track to be played on an audio output 125 separately from a video track.

It is noted that each window/display may be a physical display. Additionally or alternatively, a window/display may be a software-rendered window. Additionally, the multi-layered display technology may use two or more stacked display layers implemented by software.

The possibility of performing video/audio content detection based upon video/audio finger printing analysis, for example using event handler mechanisms, may allow various control functionalities of the video content stream, for example operable and configurable by the end user.

Where appropriate, based upon an event detection, the media stream containing the advertising message, for example, may be directed to a separate window in multi-window environment (such as PC 150D) or to a separate layer in a multi-layered environment, change the viewing window into a floatable window in environments such as a smartphone or a tablet (160D), as described hereinafter, thus allowing the user to continue with preferred engagement.

It is noted that devices such as smartphones or tablets, for example, supporting a mobile operating system (such as the Android operating system developed by Google, Inc., or iOS developed by Apple, Inc.), may possess the ability of displaying multiple user interfaces (applications) simultaneously by showing each application in a separate layer (multi-layered environment), while some of the layers may be transparent or translucent.

Optionally, the media stream containing the advertising message may be directed to a banner, where the banner may be a movable or a static object. Additionally or alternatively, the media stream containing the advertising message may support separation of the audio from the video stream of the advertising message, where appropriate.

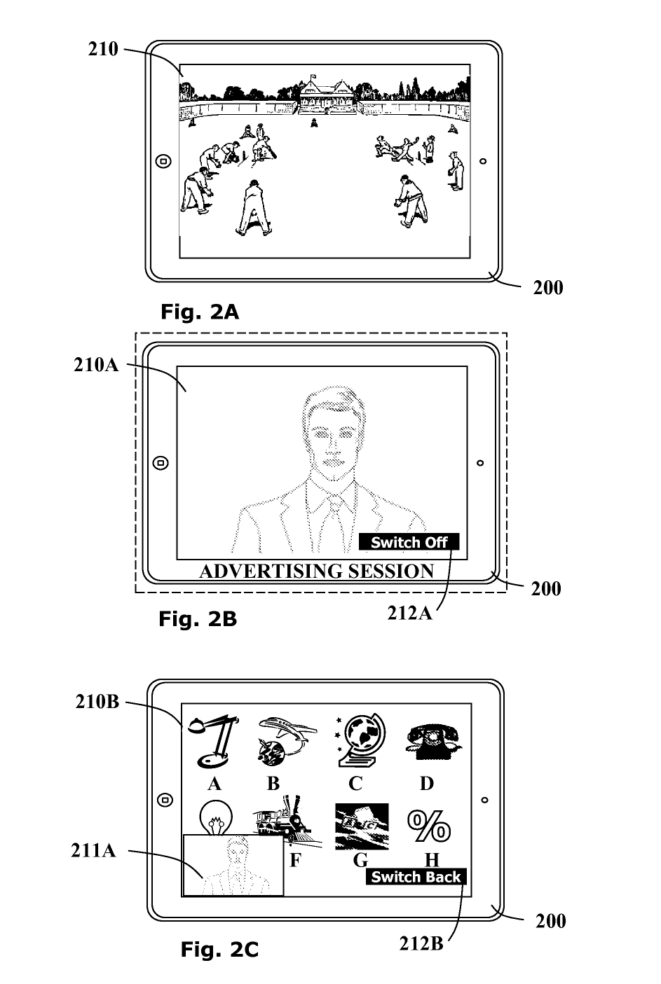

Reference is now made to FIGS. 2A-D, illustrating various screen shots of an example of a media stream containing an advertising message with its associated events.

A mobile device 200, such as a laptop, a portable computer, a tablet, a smartphone and the like, may be connected to a video content provider while displaying a video stream content, optionally disrupted with an advertising message. With particular reference to FIG. 2A, the user may have selected to view a sports match 210 in a first presentation mode via the communication network. Accordingly, the mobile device screen displays the media received via the communication network.

It is noted that the user may have the option to set personal preferences, for example by requesting manual or automatic response to advertising events. The user may request to be notified of event occurrence, thereafter deciding whether to watch the advertising content or engage in other activities. Additionally or alternatively, the user may request automatic response.

Optionally, the user may configure the user preference profile, to determine additional types of responses upon the occurrence of an event, such as presenting a notification message, sound options such as beeping, music and the like.

A first example of an advertising event notification, for example, is illustrated in FIG. 2B. The software module installed on the mobile device may receive a control signal indicating the starting of an advertising event. Accordingly, the incoming video stream, now containing the advertising message stream 211A may be displayed on the screen in a second presentation mode, optionally with a ‘Switch Off’ button 212A, allowing the user to relegate the current content into a minimized floating window view.

FIG. 2C illustrates an example of an automatic response to an advertising event notification. Upon receiving a control signal via the content provider API, indicating an advertising start event, the viewable video screen may change into a third presentation mode in which the video content is displayed in a minimized floatable state as indicated by 211A, enabling the user to drag the floatable screen around, allowing to continue with other desired engagement.

As appropriate, the set of icons A-G shown on the user screen 210B, for example, may represent functional applications of the operating system or other third party user installed applications.

As appropriate, the program will automatically resume in the first presentation mode, if so configured, when another control signal is received via the content provider API, indicating an advertising end event. Additionally or alternatively, the floatable window may be maximized at any stage, thereby returning the screen to the first presentation mode, by pressing the ‘Switch Back’ button 212B, for example.

It is noted that the screen button 212B is presented here by way of example only. Optionally, various input methods may be applied, such as voice control, touch-screen, pointing devices and the like.

Another example of a presentation mode for user engagement is illustrated in FIG. 2D, where the user screen 210C is in a state of normal user engagement with a specific user's application 214. The video streamed window 210A is minimized, and optionally, may be maximized at any stage, by pressing the ‘Switch Back’ button.

### Multi Layers:

Multi-layered display technology may display two or more stacked layers separated by apparent depth, which may be implemented by software. When viewing objects in a multi-layered display, objects displayed on the front layer hide objects on the back layers. Multi layered displays may have their different logical layers correspond to different applications, where each application lies on top or below other applications with each optionally displayed with different transparencies.

Additionally, the technology may provide better viewing of the display by rearranging the order of the layers and by making use of the transparency of the front layer. Thus, when presenting video content in a partial screen display a first segment of the video content may be displayed at a first transparency level and a second segment of the video content may be displayed at a second transparency level, where one of the transparency levels, the first transparency level or the second transparency level, may have a zero transparency level corresponding to an opaque mode.

Additionally or alternatively, the video content may be presented by not displaying it on a foreground display layer, with other applications displayed on other display layers in front of the video content. Optionally, it is noted that the other display layers may be partially transparent.

Additionally or alternatively, if a media terminal includes a display having a stack of ordered layers when displaying the video content in partial display mode, displaying a first segment of video content in a first display mode may occur at a first position in the ordered stack and displaying a second segment of video content in a second display mode may occur at a second display layer at a second position in the stack.

### Event Detection and Presentation:

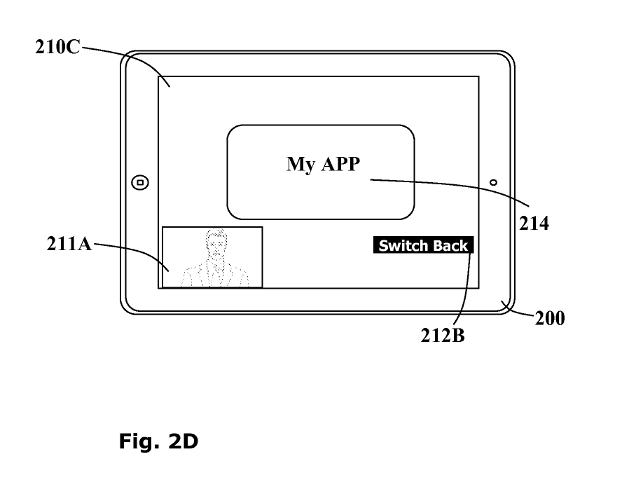

Reference is now made to the flowchart of FIG. 3 representing a method 300 for operating a media terminal in digital environments. The method 300 may be implemented in a system such as described hereinabove, for example implemented by a processor (not shown) running the video/audio event-driven platform on a media client device of a user, responding to video/audio events accordingly, such as an advertising break (begin/end), penalty kick in a sporting match, starting of a specific video/audio program, or any other suitable event.

The method 300, for operating a media terminal in an improved manner, includes presenting a first segment of video content in a first presentation mode (step 302), on a media terminal such as a computer, a laptop, a smartphone, a tablet, a handheld device, or any other suitable media terminal, detecting, by the media terminal, an event in the video content (step 304), selecting, upon detecting the desired event by the media terminal, a second presentation mode (step 306), and presenting the second segment of the video content in the previously selected second presentation mode (step 308).

Optionally, the method 300, subsequent to the presenting of the second segment of video content, may further include detecting, by the media terminal, a second event in the video content (step 310), and upon detecting the second event, presenting a third segment of video content in the first presentation mode (step 312).

The step 308, for presenting the second segment of video content in the second presentation mode includes presenting a confirmation request to a user (step 322) upon detecting the event within the video content, receiving a confirmation response from the user for the request (step 324), and presenting the second segment of video content in the second presentation mode (step 326).

The step 312, following detecting a second event in the video content, if existing, for presenting the third segment of video content in the first presentation mode includes presenting a confirmation request to a user (step 332) upon detecting the second event in the video content, receiving a confirmation response from the user for the request (step 334), and presenting the third segment of video content in the first presentation mode (step 336).

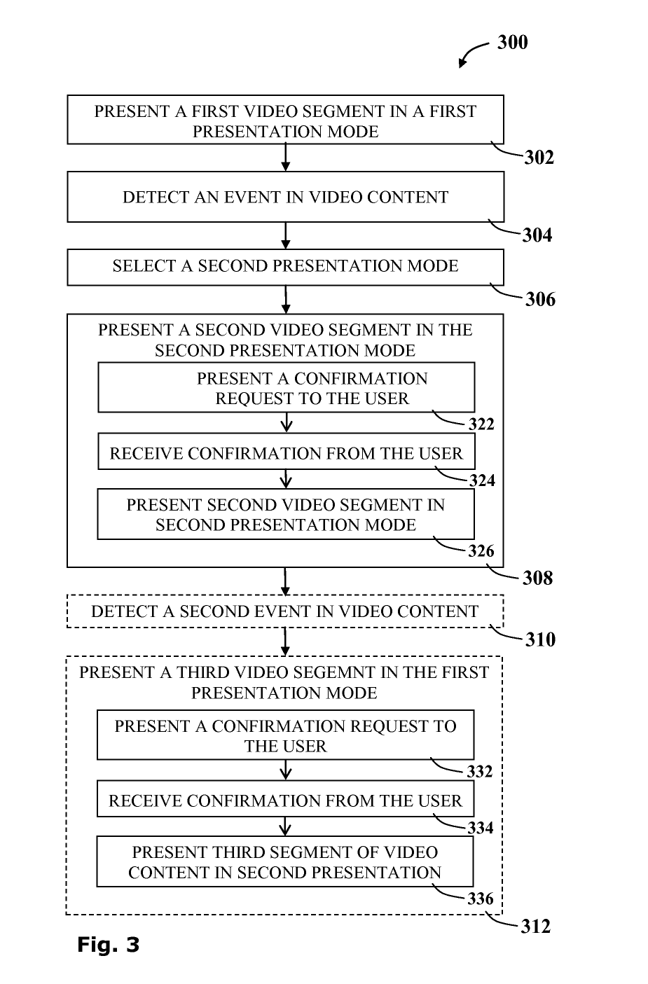

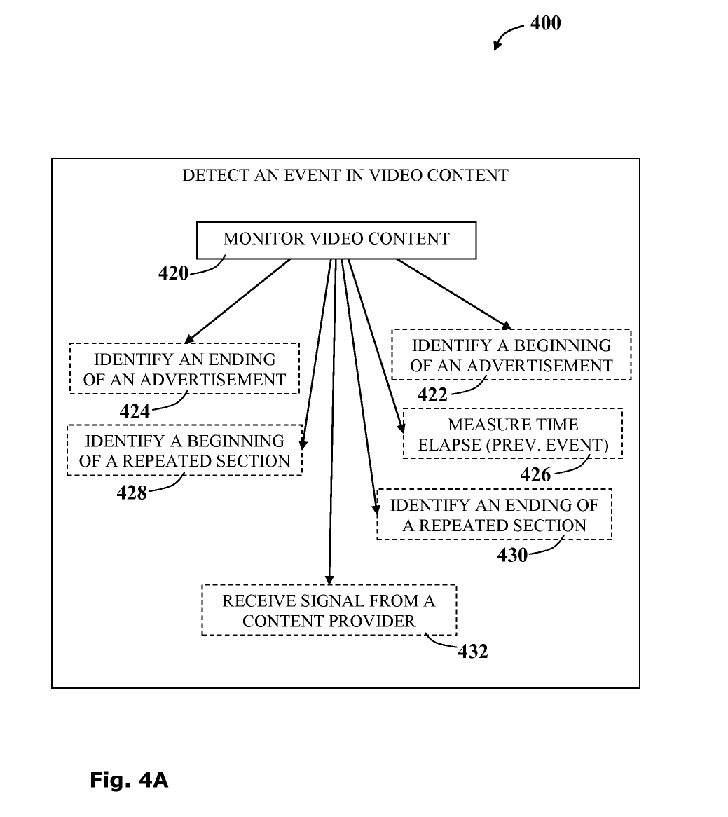

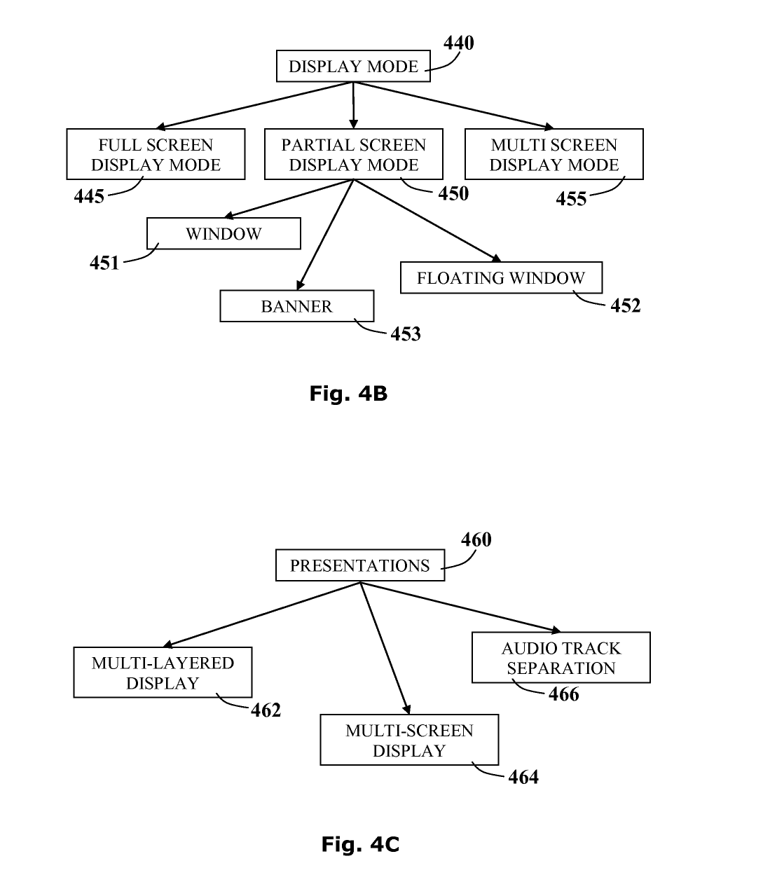

It is noted that the monitoring options of event detection is described and further detailed in the illustration of FIG. 4A.

It is further noted that the first and second presentation modes may be displaying the video content in a full-screen display mode, in a partial screen display mode, or presented in a secondary display as described hereinafter with reference to FIG. 4B.

Reference is now made to FIG. 4A, representing an illustration 400 of examples of monitoring options for detecting an event in the video content displayed on a media terminal in digital environments. The method 400 may be used with the method 300 such as a described hereinabove, to provide detection indications to the method 300.

The method 400 for detecting an event in the video content displayed on a media terminal, includes monitoring by the media terminal of the currently presented video content (step 420), with monitoring allowing detection of various events in the video content, optionally identifying by the media terminal a beginning of an advertisement message (step 422), optionally identifying by the media terminal an ending of the previously identified advertisement message (step 424), optionally identifying by the media terminal a beginning of a repeated section of the video content (step 426), and optionally identifying by the media terminal an ending of a previously identified repeated section of the video content (step 428). Optionally the method may start measuring elapsed time from a previous event and further detecting that the elapsed time has exceeded a pre-defined threshold value (step 430).

Additionally or alternatively, the video content may be provided by a video content provider, and the step of monitoring video content may be driven by receiving a signal, by the media terminal, from the content provider associated with the currently displayed video content (step 432).

Reference is now made to the block diagram of FIG. 4B, representing examples of display modes 440 of the media terminal display system in a video monitoring system as described hereinabove.

The operational display modes 440 in a media terminal in digital environments may include a full screen display mode 445, with the video content occupying maximum of screen area, partial display screen 450, with the video content occupying only part of the screen, while allowing other parts of the screen to host additional functionalities associated with the currently displayed video content or other programs. Another alternative is a multi-screen display mode 455, with the video content displayed on a first screen and additional associated functionalities being displayed on a second screen.

It is noted that when in partial display screen mode 450, the visual display may be presented in a window 451, in a floating window 452 capable of being moved or dragged around on the screen, and/or in a banner 453.

Reference is now made to the block diagram of FIG. 4C, representing examples of presentation displays 460 of the media terminal display system.

Examples of operational display presentation 460 in a media terminal in digital environments may include a multi-layered display 462, a multi-screen display 464, and a separation of the audio track 466.

It is noted that when in multi-screen display or multi-layered display, presenting the first segment of video content in a first presentation mode may display the first segment of video content on a first display, and presenting the second segment of video content in a second presentation mode may display the video content on a second display, wherein the first display or the second display may be another screen, in a multi-screen system, or another layer in a multi-layered display system.

It is further noted that when referring to the presentation of first and second segments of video content, display may use a transparency level for each segment that may be different or the same. For example, a zero transparency level may correspond to an opaque mode.

Additionally, when presenting content segments in a layered system, one of the steps of presenting the first segment of video content and presenting the second segment of video content may be displayed on a foreground display layer. The other of the steps of presenting the first segment of video content and presenting the second segment of video content may be displayed on another display layer in front of the video content, as described hereinafter.

It is further noted that when the content comprises an audio track and a video track, any of the steps of presenting the first segment of video content and presenting the second segment of video content may be configured to play only the audio track, achieving audio/video separation.

The scope of the disclosed subject matter is defined by the appended claims and includes both combinations and sub combinations of the various features described hereinabove as well as variations and modifications thereof, which would occur to persons skilled in the art upon reading the foregoing description.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method for operating a media terminal in an improved manner, said method comprising:
presenting a first segment of video content in a first presentation mode;
detecting, by said media terminal, an event in said video content;
upon detecting said event selecting, by said media terminal, a second presentation mode; and
presenting a second segment of video content in said second presentation mode.

2. The method of claim 1 wherein the step of detecting an event comprises said media terminal monitoring said video content.

3. The method of claim 1 wherein the step of detecting an event comprises said media terminal identifying a beginning of an advertisement.

4. The method of claim 1 wherein the step of detecting an event comprises said media terminal identifying an ending of an advertisement.

5. The method of claim 1 wherein the step of detecting an event comprises said media terminal identifying a beginning of a repeated section of said video content.

6. The method of claim 1 wherein the step of detecting an event comprises said media terminal identifying an ending of a repeated section of said video content.

7. The method of claim 1 wherein the step of detecting an event comprises:
measuring time elapsed since a previous event; and
detecting that said elapsed time has exceeded a threshold value.

8. The method of claim 1 wherein said video content is provided by a content provider and the step of detecting an event comprises:
said media terminal receiving a signal from said content provider.

9. The method of claim 1 wherein one of the steps of presenting said first segment of video content and presenting said second segment of video content comprises displaying said video content in a full-screen display mode.

10. The method of claim 9 wherein another one of the steps of presenting said first segment of video content and presenting said second segment of video content comprises displaying said video content in a partial screen display mode.

11. The method of claim 10 wherein said displaying said video content in said partial screen display mode comprises displaying visual content in a window.

12. The method of claim 10 wherein said displaying said video content in said partial screen display mode comprises displaying visual content in a floating window.

13. The method of claim 10 wherein said displaying said video content in said partial screen display mode comprises displaying visual content in a banner.

14. The method of claim 1 wherein presenting said first segment of video content in a first presentation mode comprises displaying said first segment of video content on a first display; and presenting said second segment of video content in a second presentation mode comprises displaying said video content on a second display.

15. The method of claim 1 wherein said video content comprises an audio track and a video track and one of the steps of presenting said first segment of video content and presenting said second segment of video content comprises playing only said audio track.

16. The method of claim 1 wherein presenting said first segment of video content in a first presentation mode comprises displaying said first segment of video content at a first transparency level; and presenting said second segment of video content in a second presentation mode comprises displaying said second segment of video content at a second transparency level.

17. The method of claim 16 wherein one of said first transparency level and said second transparency level is a zero transparency level corresponding to an opaque mode.

18. The method of claim 1 wherein one of the steps of presenting said first segment of video content and presenting said second segment of video content comprises displaying said video content on a foreground display layer and another one of the steps of presenting said first segment of video content and presenting said second segment of video content comprises displaying another display layer in front of said video content.

19. The method of claim 18 wherein said another display layer is partially transparent.

20. The method of claim 1 wherein one of the steps of presenting said first segment of video content and presenting said second segment of video content comprises displaying another display layer in front of said video content using a first transparency level and another one of the steps of presenting said first segment of video content and presenting said second segment of video content comprises displaying said another display layer in front of said video content using a second transparency level.

21. The method of claim 20 wherein one of said first transparency level and said second transparency level is a zero transparency level corresponding to an opaque mode.

22. The method of claim 1 wherein said media terminal comprises a display having a stack of ordered layers and presenting said first segment of video content in a first presentation mode comprises displaying said first segment of video content on a first display layer at a first position in said stack; and presenting said second segment of video content in a second presentation mode comprises displaying said second segment of video content on a second display layer at a second position in said stack.

23. The method of claim 22 wherein said first display layer is behind said second display layer.

24. The method of claim 22 wherein at least one of said first display layer and said second display layer is partially transparent.

25. The method of claim 1 wherein said media terminal comprises a display having a stack of ordered layers and presenting said first segment of video content in a first presentation mode comprises displaying said first segment of video content on a first display layer at a first position in said stack and at a first transparency level; and presenting said second segment of video content in a second presentation mode comprises displaying said second segment of video content on a second display layer at a second position in said stack and at a second transparency level.

26. The method of claim 25, wherein one of said first transparency level and said second transparency level is a zero transparency level corresponding to an opaque mode.

27. The method of claim 1 wherein the step of presenting said second segment of video content comprises:
upon detecting said event presenting a confirmation request to a user;
receiving a confirmation from said user; and
presenting said second segment of video content in said second presentation mode.

28. The method of claim 1 further comprising:
subsequent to the presenting of said second segment of video content detecting, by said media terminal, a second event; and
upon detecting said second event said media terminal presenting a third segment of video content in said first presentation mode.

29. The method of claim 28 wherein the step of presenting said third segment of video content comprises:
upon detecting said second event presenting a confirmation request to a user;
receiving a confirmation from said user; and
presenting said third segment of video content in said first presentation mode.

30. The method of claim 28 wherein said second event is selected from a group consisting of:
a beginning of an advertisement;
an ending of an advertisement;
a beginning of a repeated section of said video content;
an ending of a repeated section of said video content;
an ending of a time interval since a previous event; and
an instruction from a user.

31. The method of claim 1 wherein said media terminal comprises at least one of: a television, a computer, a laptop, a tablet, a smartphone and a mobile communication device.

32. A media terminal operable to present video content in a plurality of presentation modes, said media terminal comprising:
at least one video display operable to present said video content; and
a mode controller operable to detect an event in said video content, and to switch from a first presentation mode to a second presentation mode according to said event, said second presentation mode being selected by said media terminal.
